(19) United States
(12) Patent Application Publication
(10) Pub. No.: US 2024/0375570 A1
(43) Pub. Date: Nov. 14, 2024

(54) IMPROVED REAR EJECT TRUCK BODY TAILGATE OPERATING SYSTEM

(71) Applicant: PHILIPPI-HAGENBUCH, INC., Peoria, IL (US)

(72) Inventor: Brock W. Emery, Mackinaw, IL (US)

(21) Appl. No.: 18/292,553

(22) PCT Filed: Jul. 29, 2022
(86) PCT No.: PCT/US2022/038901

§ 371 Date: Jan. 26, 2024

Related U.S. Application Data
(60) Provisional application No. 63/227,191, filed on Jul. 29, 2021.

(51) Int. Cl. B60P 1/00

(52) U.S. Cl. CPC B60P 1/006

(57) ABSTRACT

A tailgate operating system for a top loaded rear eject truck body includes a pulley disposed near a rear end of a truck body container. A first tension line extends over the pulley and includes a rear end and a front end. The rear end of the tension line is secured to a tailgate that is operable to close an open end of the truck body container. A coupler is secured to the front end of the tension line and is configured to selectively engage an ejector blade of the rear eject truck body such that movement of the ejector blade facilitates operation of the tailgate.

### CROSS REFERENCE TO RELATED APPLICATIONS

This application claims priority to U.S. Provisional Application No. 63/227,191, filed Jul. 29, 2021, which is hereby incorporated by reference herein in its entirety.

### FIELD

The present disclosure generally relates to a tailgate operating system for an open-top rear eject truck body.

### BACKGROUND

Trucks, such as those used in quarries, steel mills, mines, landfills and power plants, are often outfitted with rear eject truck bodies. These rear eject truck bodies utilize some mechanism, often including one or more hydraulic cylinders, to push or eject the truck body load out of the rear of the truck body. It is desirable, for reasons known to those producing such rear eject truck bodies, to limit the hydraulic cylinder stroke. To facilitate limiting the hydraulic cylinder stroke, the active load area of the truck body floor is kept short and accordingly such rear eject truck bodies are invariably outfitted with tailgates which, in a sense, are pseudo floor extensions. However, the addition of such a tailgate requires some method of operating the tailgate. The present disclosure relates to an improved method of operating such a tailgate.

The tailgates on rear eject truck bodies can be operated by several different means, but it is typically preferable for the tailgate actuation/release method to allow the tailgate to quickly open or release so as to not impede the actual load ejection. One common method of operating the tailgate is the use of hydraulic cylinder(s) in conjunction with various mechanical linkages. However, to quickly release the tailgate for safe load ejection, a hydraulically operated tailgate requires sequential hydraulic circuitry to properly sequence the full opening of the tailgate in conjunction with the load ejection.

Another alternative tailgate operating method is a mechanical approach. Such an approach may use the movement of the ejector blade in ejecting or pushing the load out of the rear eject truck body to lower and raise the tailgate. A mechanical operation of the tailgate may occur by coupling the tailgate and the ejector blade. Such a coupling may use a flexible chain or cable that is wrapped around a chain drum mounted to the outboard sides of the tailgate. As the ejector blade moves rearward, the weight of the tailgate lowers or pulls the chain drum and chain or cable until the tailgate reaches an open position.

To go from a fully closed position to a fully open position, the tailgate rotates about 90°. In the closed position the tailgate sits at about 45° to the horizon, so the circumference of the chain drum is 90°+45° or a total of 135°, almost half a full circle. In the fully closed position, the front nose portion of this chain drum often protrudes through the rear eject body floor.

The trucks that rear eject bodies are mounted on often have dual rear tires side by side similar to conventional highway semis, or the dual tires are single tires one in front or behind the other. Such tires typically oscillate up and down as undulating underfoot conditions occur. As these tires oscillate upward, they may come in contact with the floor of the rear eject truck body, and if the tire makes contact with the chain drum the tire may be severely damaged. Accordingly, the tailgate width of such trucks rear eject truck bodies typically must be wide enough that the chain drum will always be laterally outside the truck tires.

So even though a mechanically operated tailgate may be simpler to produce and operate than a hydraulic tailgate, the width of an automatic mechanical tailgate and the associated truck body may be wider than desired.

Another consideration for the design of a rear eject truck body tailgate is the type of material being hauled in the rear eject truck body. Normal material being hauled will flow easily off the tailgate. However, there are some materials that almost coagulate and stick together. Some clay like material is very much like this. If one picks these materials up with a shovel, the materials will just stick to the shovel and not fall off. Accordingly, when hauling such materials with a tailgate using a chain drum, material may pack into the area between the tailgate and the chain drum. Hydraulic operating tailgates are also susceptible to collecting such clay materials, and the materials can get packed into the tailgate operating mechanisms.

The present inventor has recognized that an alternative configuration for a mechanically operated tailgate that allows for a narrower truck body and that avoids collecting material on the surfaces thereof would be advantageous.

### SUMMARY

Thus, the present disclosure provides an improved rear eject truck body tailgate operating mechanism.

In a first aspect, the disclosure provides a rear eject truck body comprising:
a truck body container including a floor, opposing sidewalls, and an open rear end;
an ejector blade configured to move along the floor between a retracted position and an extended position toward the open rear end of the truck body container;
a tailgate extending across the open rear end of the truck body container and rotatable between an upper closed position and a lower open position; and
a tailgate operating system comprising:
   a pulley disposed near the rear end of the truck body container,
   a first tension line extending over the pulley, the first tension line including a rear end secured to the tailgate and a front end, and
   a coupler secured to the front end of the tension line and configured to selectively engage the ejector blade such that movement of the ejector blade facilitates opening and closing of the tailgate.

In another aspect, the disclosure provides another rear eject truck body comprising: a truck body container including a floor, opposing sidewalls, and an open rear end;
an ejector blade configured to move along the floor between a retracted position and an extended position toward the open rear end of the truck body container;
a tailgate extending across the open rear end of the truck body container and rotatable between an upper closed position and a lower open position; and
a tailgate operating system comprising:
   a pulley disposed near the rear end of the truck body container,
   a first tension line extending over the pulley, the first tension line including a rear end and a front end, and
   a coupler secured to the front end of the tension line and configured to selectively engage the ejector blade such that movement of the ejector blade facilitates operation of the tailgate operating system; and
a rotating structure including a tailgate, secured to the truck body container by a hinged coupling, and attached to the rear end of the first tension line, wherein operation of the tailgate operating system moves the rotating structure from a closed position, in which the tailgate is adjacent to the opposing sidewalls of the truck body container, toward an open position such that the entire rotating structure separates from the sidewalls of the truck body container so as to avoid material buildup on the tailgate.

In another aspect, the disclosure provides a tailgate operating system for an open top rear eject truck body, the tailgate operating system comprising:
a pulley disposed near a rear end of a truck body container,
a first tension line extending over the pulley, the first tension line including a rear end and a front end, the rear end being secured to a tailgate that is operable between opening and closing an open end of the truck body container, and
a coupler secured to the front end of the tension line and configured to selectively engage an ejector blade of the rear eject truck body such that movement of the ejector blade facilitates operation of the tailgate.

These and other aspects of the disclosure will be evident to those of ordinary skill in the art from the following description.

### BRIEF DESCRIPTION OF THE DRAWINGS

The present disclosure is described in greater detail below based on the exemplary figures. The figures are not necessarily to scale and certain features and certain views of the figures may be exaggerated in scale or depicted in schematic form for clarity or conciseness. The disclosure is not limited to the exemplary embodiments. All features described and/or illustrated herein can be used alone or combined in different combinations in embodiments of the disclosure. Features and advantages of various embodiments of the disclosure will become apparent by reading the following detailed description with reference to the figures which illustrate the following:

FIG. 1 is a schematic side view of a truck including a rear eject truck body according to an embodiment of the disclosure with the ejector blade in a retracted position and the tailgate in a closed position;

FIG. 2 is a schematic rear view of the truck of FIG. 1 with the ejector blade in a retracted position and the tailgate in a closed position;

FIG. 3 is a schematic side view of the truck of FIG. 1 with the ejector blade in the extended position and the tailgate in an open position;

FIG. 4 is a schematic rear view of a the truck of FIG. 1 with the ejector blade in the extended position and the tailgate in an open position;

FIG. 5 is a schematic rear perspective view of a portion of the truck of FIG. 1 with the ejector blade in a retracted position and the tailgate in a closed position;

FIG. 6 is a schematic perspective side view of a rear eject truck body of the truck of FIG. 1 with the ejector blade in an intermediate position;

FIG. 7 is a schematic front view of the rear eject truck body of the truck of FIG. 1;

FIG. 8 is a schematic front perspective view of the rear eject truck body of the truck of FIG. 1;

FIG. 9 is an enlarged view of a portion of a tailgate operating mechanism of the truck of FIG. 1;

FIG. 10 is a schematic front perspective view of a portion of the rear eject truck body of the truck of FIG. 1;

FIG. 11 is a schematic isolation view of components of the rear eject truck body of the truck of FIG. 1 with the tailgate closed;

FIG. 12 is a schematic isolation view of components of the rear eject truck body of the truck of FIG. 1 with the tailgate open;

FIG. 13 is an enlarged side view of a portion of the rear eject truck body of the truck of FIG. 1;

FIG. 14 is an enlarged cut away view of a portion of the rear eject truck body of the truck of FIG. 1; and

FIGS. 15A, 15B and 15C are schematic side views of a portion of the rear eject truck body of the truck of FIG. 1 showing a progression of the opening of a tailgate.

### DETAILED DESCRIPTION

As set forth above, the present inventor that an alternative configuration for a mechanically operated tailgate that allows for a narrower truck body and that avoids collecting material on the surfaces thereof would be advantageous.

In one aspect, the disclosure provides a tailgate operating system for a rear eject truck body. The tailgate operating system includes a pulley disposed near a rear end of a truck body container. A first tension line extends over the pulley and has a rear end and a front end. The rear end of the tension line is secured to a tailgate that is operable to close an open end of the truck body container. A coupler is secured to the front end of the tension line and is configured to selectively engage an ejector blade of the rear eject truck body such that movement of the ejector blade facilitates operation of the tailgate.

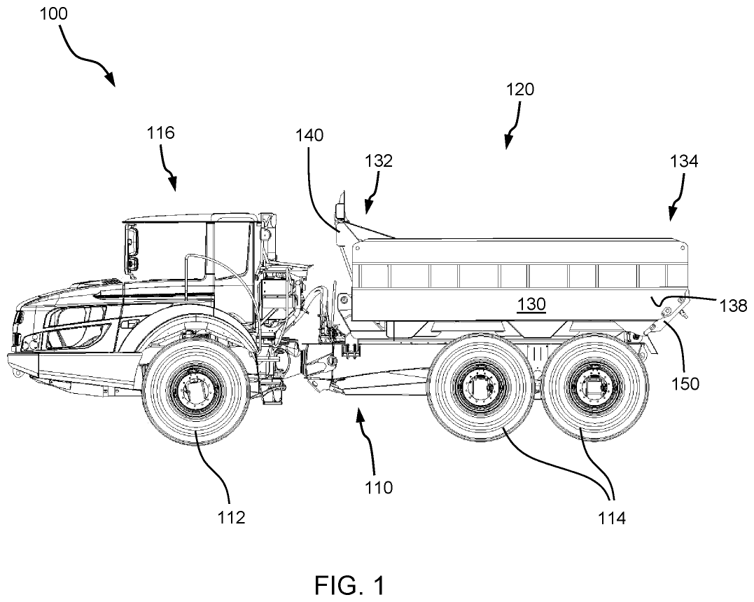

FIG. 1 is a side view of a of a truck 100 that includes an open top rear eject truck body 120 according to an embodiment of the disclosure. The rear eject truck body 120 can be top loaded and is disposed on a chassis 110 that includes a frame and a plurality of front wheels 112 rear wheels 114 mounted to the frame. Each of the wheels 112, 114 includes a tire that supports the truck. A cab 116 is positioned over the front wheels 112 for accommodating a control systems and a driver. In various other embodiments, the truck may have other configurations, such as a different shaped chassis, a different number of wheels, or other variations. For example, embodiments of the disclosure may be incorporated into autonomous trucks, which may have alternative configurations, such as excluding space for a driver.

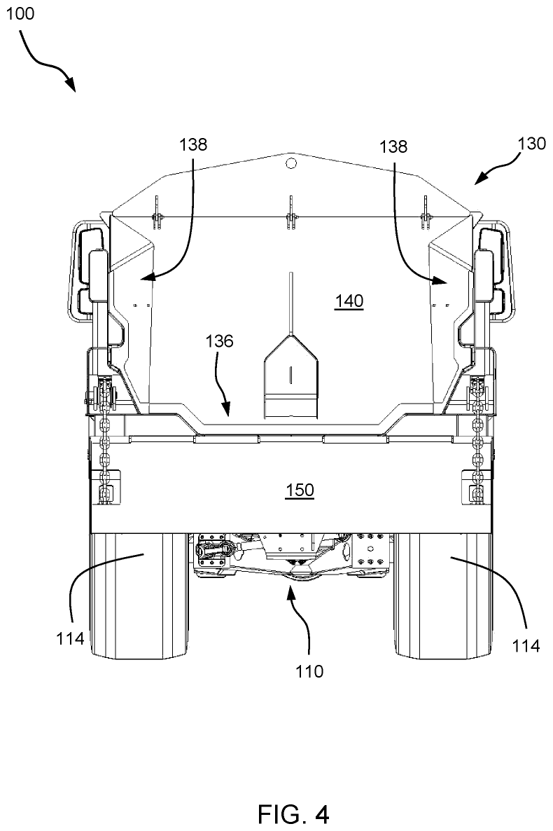

The rear eject truck body 120 includes a truck body container 130 that has a front end 132 and a rear end 134. The truck body container 130 is formed by a floor 136 (FIG. 4) and opposing sidewalls 138. The rear eject truck body 120 also includes an ejector blade 140 that is shown in FIG. 1 in a retracted position near the front end 132 of truck body container 130. The ejector blade 140 is configured to move along the floor of the truck body container 130 from the retracted position to an extended position toward the rear end 134 of the truck body 120. The rear end 134 of truck body container 130 is open so that material hauled in the truck body container 130 may be expelled from the back of the truck 100 when the ejector blade 140 is moved to the extend position. In order to contain the hauled material in the truck body container 130 during loading and transport, the rear eject truck body 120 also includes a tailgate 150 that extends across the open rear end 134 of the truck body container 130. In FIG. 1 the tailgate 150 is shown in an upper closed position, where the tailgate 150 can impede hauled material from falling out of the truck body container 130.

The terms front and rear, as used herein, are consistently made in reference to the direction of the truck. For example, the surface of the ejector blade 140 that contacts material in the truck body container 130 is referred to as the rear of the ejector blade.

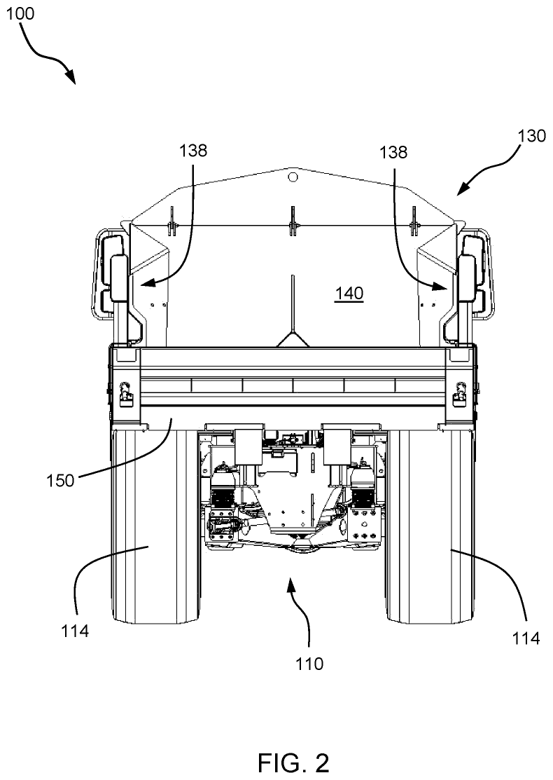

FIG. 2 shows a rear view of the truck 100 including rear eject truck body 120 disposed over the chassis 110 and rear wheels 114. As shown, the ejector blade 140 extends across the width of the rear eject truck body 120 between the opposing sidewalls 138 of the truck body container 130. In FIG. 2, the lower portion of ejector blade 140 is obscured by the tailgate 150, which is in the upper closed position.

As shown, the width of the truck body container 130 is substantially the same as the distance between the outer sides of the tires of the rear wheels 114. Accordingly, each of the sidewalls 138 is positioned over the tires of the rear wheels 114. Such a configuration is possible because of the tailgate operating system of the disclosure, as explained further below.

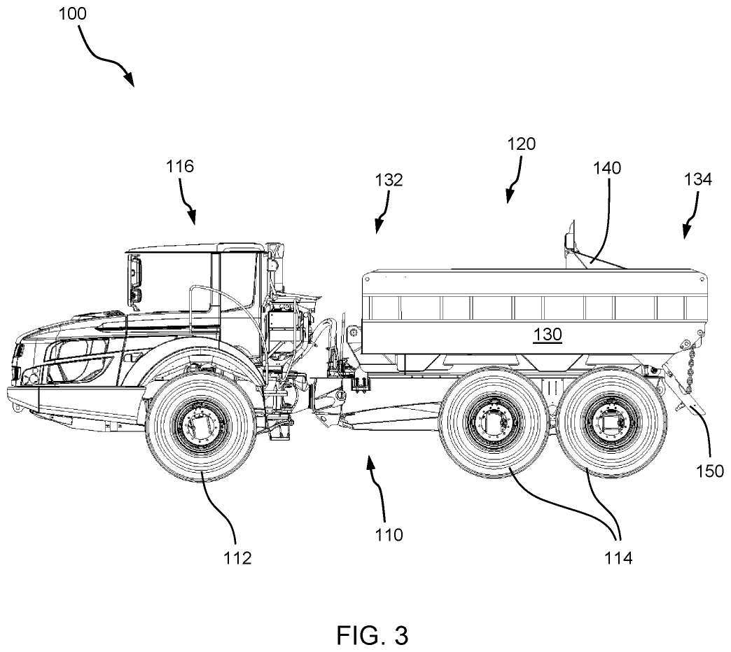

FIG. 3 shows a side view of the truck 100 with the ejector blade 140 of the rear eject truck body 120 in the fully extended position toward the rear end 134 of the truck body container 130. Further, the tailgate 150 has been rotated down to a lower open position. In such a position, the rear end 134 of the truck body container 130 is open and unobstructed, which allows the ejector blade 140 to expel any material held in the truck body container 130.

FIG. 4 shows the rear view of truck 100 with the ejector blade 140 and tailgate 150 in the same positions as in FIG. 3, i.e., with the ejector blade 140 in the extended position and the tailgate 150 in the lower open position. With the tailgate 150 lowered, the full height of the ejector blade 140 can be seen as well as the floor 136 of the truck body container 130.

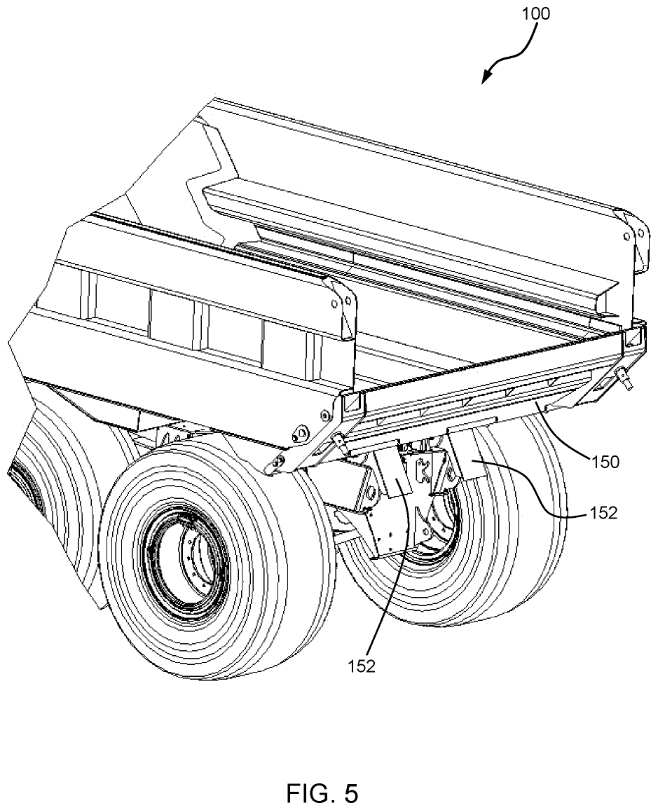

In some embodiments, a support structure is provided to bear the weight of the tailgate when it is in the open position. Such a support structure can prevent the tailgate operating system from having to hold the full weight of the tailgate while the tailgate is in the open position. For example, in truck 100, such a support structure is provided by a pair of tailgate stops 152, as shown in FIG. 5. These tailgate stops 152 are formed by flat angled surfaces that mate with the tailgate 150 when it opens. As a result, the tailgate stops define the full open position of tailgate 150 and can support the tailgate 150 when it has been lowered to the open position.

While the illustrated support structure includes two tailgate stops 152, in other embodiments, the support structure may be formed by a single stop, or by more than two stops. Likewise, in some embodiments, the support structure may have a different configuration, such as a beam or one or more flanges. Such a support structure may be formed as a part of the rear eject truck body, or may be formed by part of the truck chassis. On the other hand, in some embodiments, the truck may not include any standalone support structure for holding the tailgate. For example, the hinge of the tailgate may only allow for limited rotation and may hold the tailgate in the open position, or the tailgate may be held by the tailgate operating mechanism.

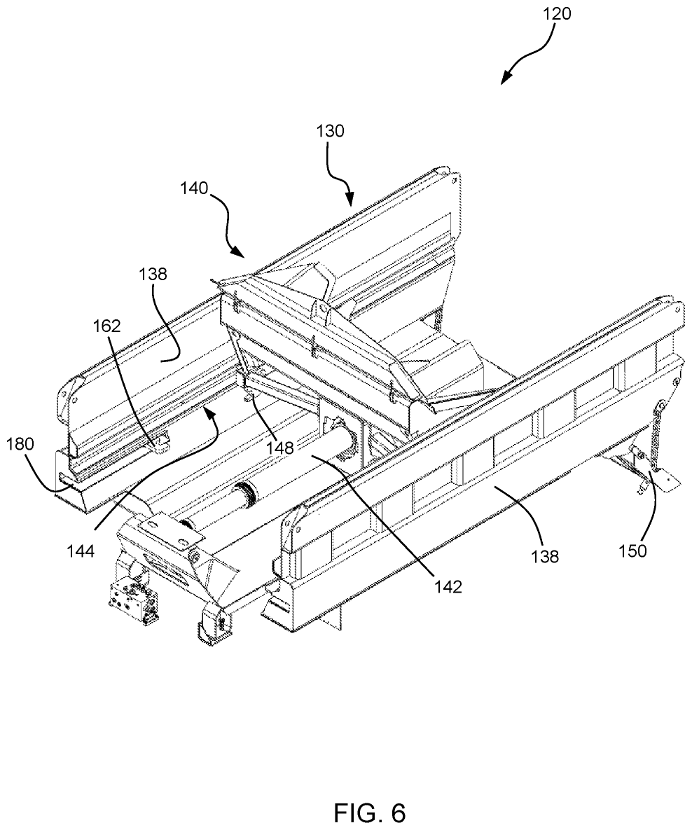

FIG. 6 shows a front perspective view of the rear eject truck body 120 with the tailgate 150 open and the ejector blade 140 in the extended position. As shown in FIG. 6, the ejector blade 140 is moved by a hydraulic cylinder assembly 142 that pushes the ejector blade 140 from the front in order to move the ejector blade rearward from a retracted position to an extended position, such that material in the truck body container 130 is expelled from the container.

Likewise, as the hydraulic cylinder assembly 142 retracts, the ejector blade 140 is moved forward to the retracted position, in which the truck body container 130 is empty and ready to receive additional material. A detailed description of the components of a hydraulic cylinder assembly, the integration of the hydraulic cylinder with an ejector blade, and the operation thereof is provided in U.S. Pat. No. 7,878,751, which is hereby incorporated by reference in its entirety.

The sidewalls 138 of the truck body container 130 include tracks 144 that guide the ejector blade 140 along the length of the truck body container 130 in order to promote a smooth linear movement of the ejector blade 140 along the truck body floor 136. In the illustrated embodiment, the tracks are formed as channels that extend along the length of the sidewalls 138. However, in other embodiments, the tracks may have another configuration.

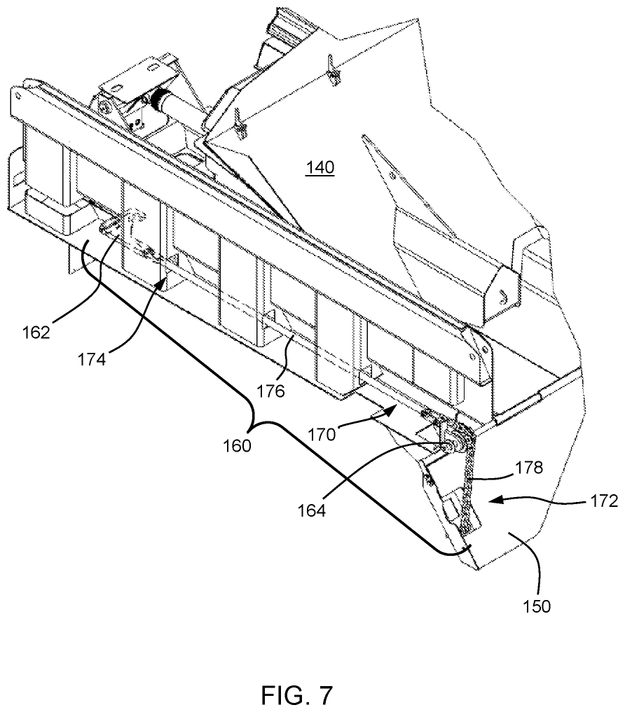

FIGS. 7-14 illustrate components of a tailgate operating system 160 of the truck 100 in the illustrated embodiment. As shown in FIG. 7, the tailgate operating system 160 includes a tension line 170 with a rear end 172 that is attached to the tailgate 150 and a front end 174 that is secured to a coupler 162. As explained further below, the coupler 162 selectively engages with the ejector blade 140 for extending and retracting the tension line 170. At least a portion of the tension line 170 is flexible and passes over a pulley 164. Accordingly, as the tension line 170 is extended toward the rear of the truck 100, the rear end 172 of the tension line 170 allows the tailgate to rotate downward to the open position.

The illustrated tension line 170 includes a rod 176 that forms the front end of the tension line 170 and flexible portion formed by a chain 178 that extends over the pulley 164. The rod 176 is secured to the coupler 162 and cannot pass over the pulley 164, thereby limiting the rearward movement of the tension line 170. In other embodiments, however, the entire tension line may be formed by a flexible structure, such as the chain 178. Further, while the flexible portion of tension line 170 is formed by a chain 178, in other embodiments the flexible portion of the tension line may be formed by a different flexible element, such as a cable.

The coupler 162 is configured to engage with the ejector blade 140 over a portion of the movement of the ejector blade 140 near the retracted position of the ejector blade 140. Accordingly, as the ejector blade 140 moves rearward toward the extended position, the tension line 170 also moves rearward so as to allow rotation of the tailgate 150 to the open position.

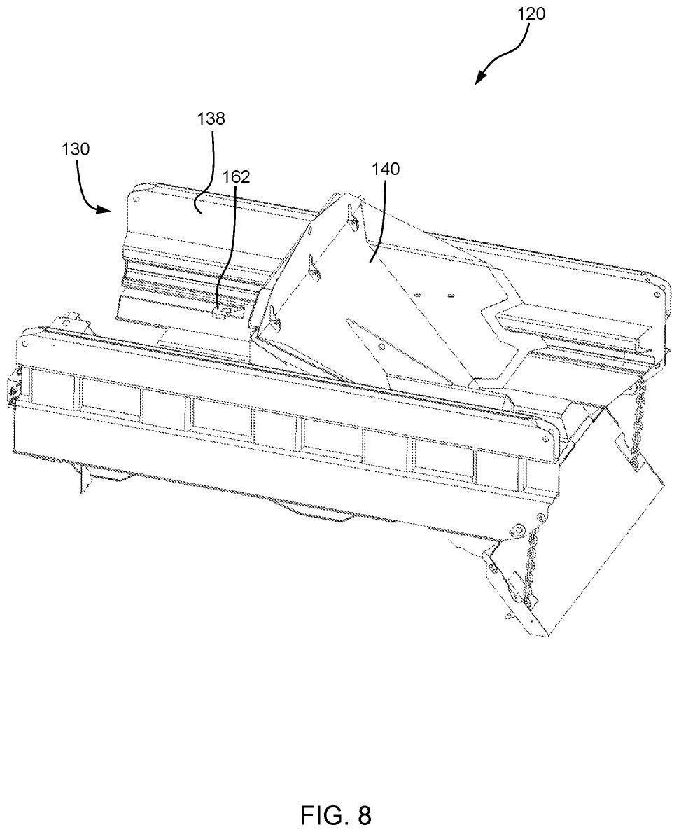

In some embodiments, the coupler is formed as a hook that engages the ejector blade so that the tension line and ejector blade move together over the front portion of the movement of the ejector blade. For example, as shown in FIGS. 6 and 8, the coupler 162 of rear eject truck body 120 is formed as a hook that extends inward from the sidewall 138 of the truck body container 130 so as to mate with a companion pocket 148 (FIG. 6) on the front side of the ejector blade.

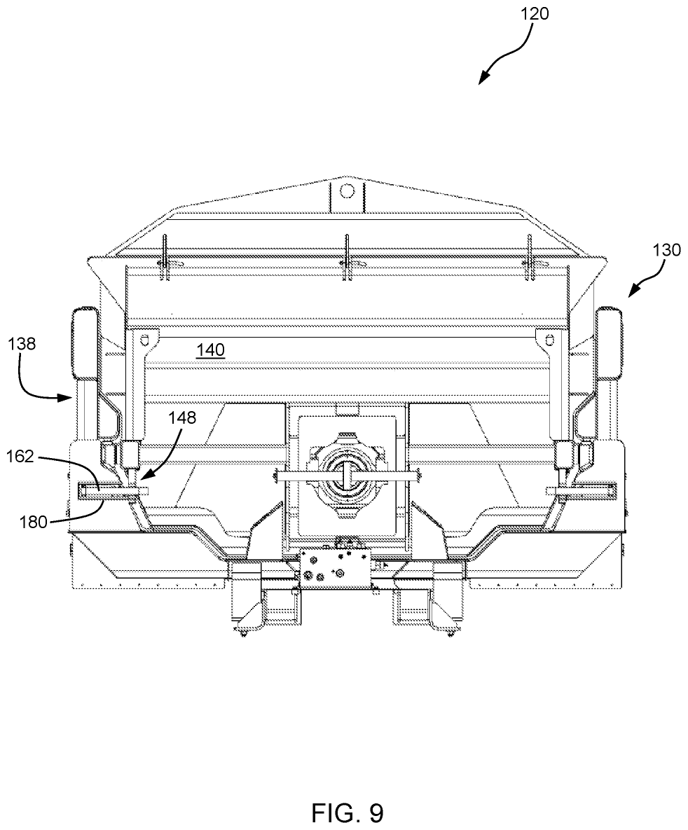

As shown in FIGS. 6 and 9, the coupler 162, as well as a substantial portion of the tension line, is held within a slot 180 in one of the sidewalls 138 of the truck body container 130. The hook that forms coupler 162 extends inward from the sidewall 138 in order to engage the companion pocket 148 of the ejector blade 140. As shown in FIG. 6, much of the slot 180 along the length of the truck body container 130 is enclosed, which avoids hauled material from entering the slot and interfering with the movement of the tension line. The front end of slot 180, on the other hand, is open so that the hook 162 can extend inward to engage the ejector blade 140.

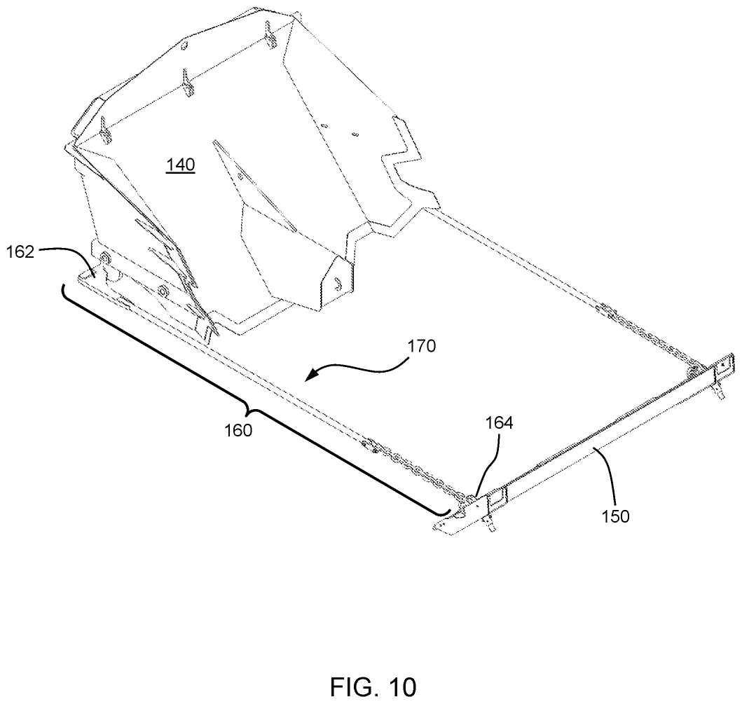

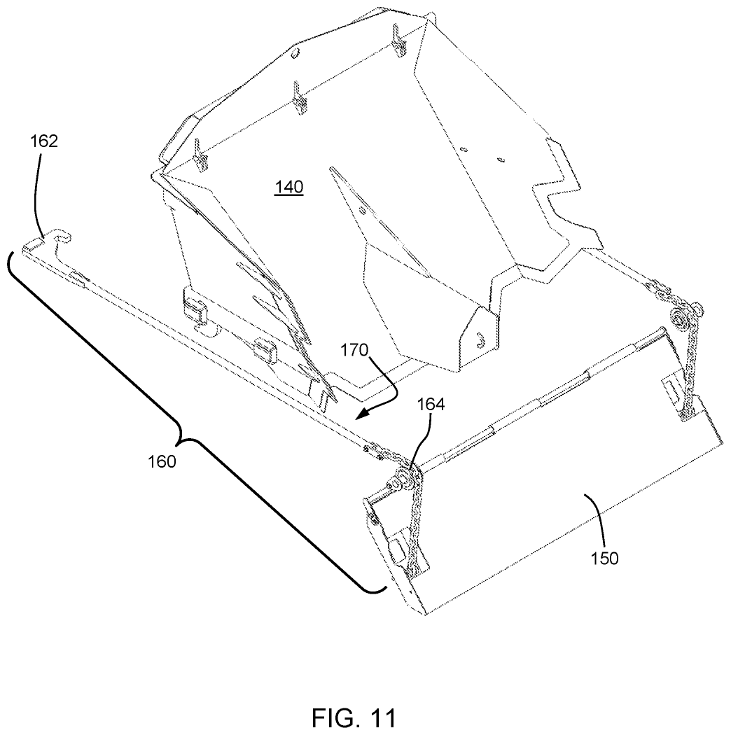

FIGS. 10 and 11 are isolated views showing only the ejector blade 140, tailgate operating system 160, and the tailgate 150. FIG. 10 shows the ejector blade 140 in the fully retracted position. In this position, the ejector blade 140 is engaging the coupler 162 of the tailgate operating system 160 so as to hold the tension line 170 in a forward position. In turn, the tension line 170 has rotated the tailgate 150 to the upper position where the tailgate 150 is adjacent to the pulley 164.

In FIG. 11, the ejector blade 140 is shown in the extended position near the rear end of the truck. As the ejector blade 140 traveled from the retracted position to the extended position, the tailgate operating system 160 was allowed to move rearward with the ejector blade 140, which enabled the tailgate 150 to be lowered by the tension line 170 as it rolled over the pulley 164. Once the tailgate 150 reached the fully opened position, the tailgate 150 and tension line 170 came to rest, while the ejector blade 140 continued moving toward the extended position. This continued movement of the ejector blade 140 caused the coupler 162 to disengage from the ejector blade 140, as shown in FIG. 11.

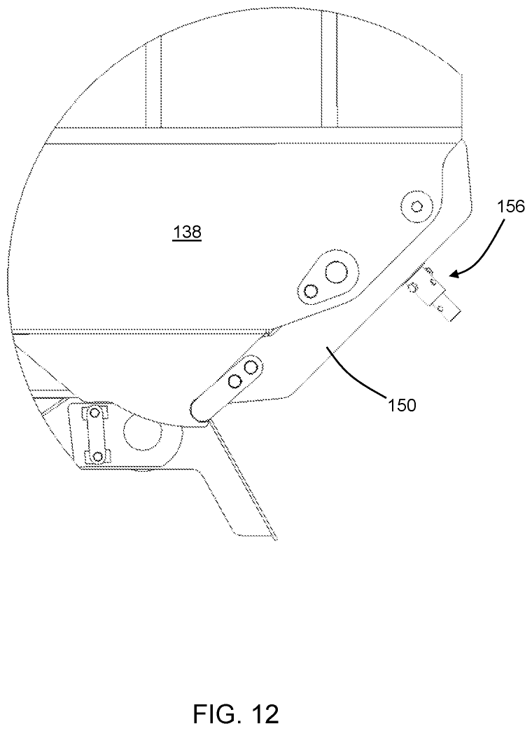

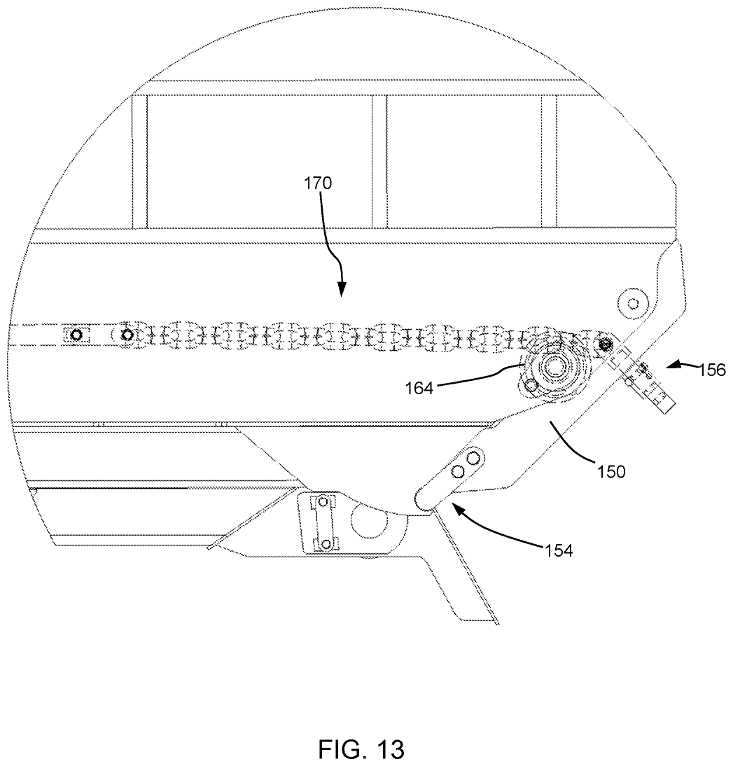

FIG. 12 shows an enlarged side view of the tailgate 150 in a closed position. The tailgate 150 is rotated and sits adjacent to the sidewalls 138. An anchor 156 secures the tension line 170 to the tailgate 150. As shown in FIG. 13, this anchor 156 is secured to the tension line 170 which causes the tailgate 150 to raise with movement of the tension line 170, as discussed above. FIG. 13 also shows the position of the pulley 164 near the rear end of sidewall 138. As shown, when the tailgate 150 is raised, the tailgate 150 is in close proximity to the pulley 164. Moreover, the pulley 164 is positioned further to the rear than the hinged coupling 154 of tailgate 150.

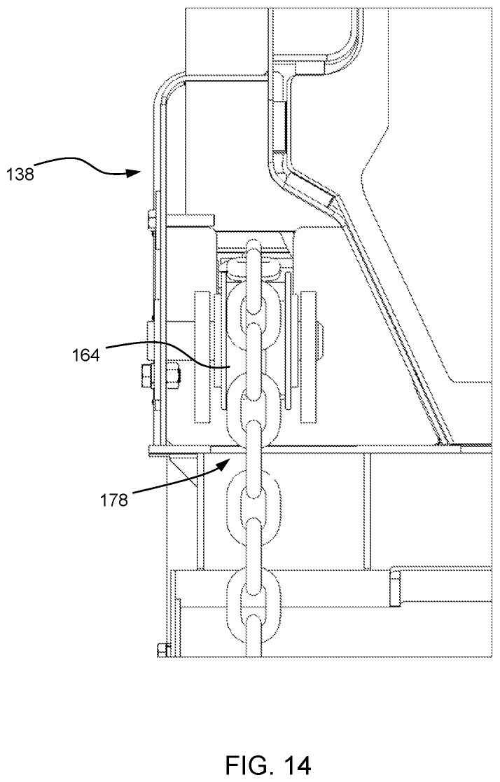

As shown in FIG. 14, the pulley 164 sits in a cavity within the sidewall 138 of the truck body container. As a result, the flexible portion 178 of the tension line 170 is the only part of the tailgate operating system 160 that is exposed. This reduces the likelihood of material buildup on components of the tailgate operating system, which reduces maintenance and aids in performance of the tailgate operating system.

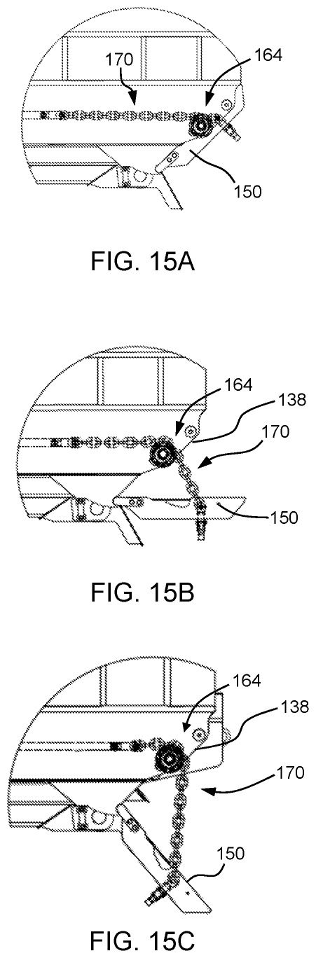

FIGS. 15A-15C illustrate the movement of the tailgate 150 by the tailgate operating system 160 as the tension line 170 rolls over the pulley 164. As shown, the tailgate 150 is formed by a rotating structure that is connected to the truck body container 130 by a hinged coupling 154. As the tailgate 150 moves downward to the open position, the entire rotating structure that forms the tailgate separates from the sidewalls 138 of the truck body container 130. Accordingly, a gap forms between this rotating structure and the truck body container. In view of this separation of the rotating structure from the sidewalls, material buildup on the tailgate is avoided. In comparison, in a tailgate configuration where the rotating structure includes a chain drum that extends through the sidewalls, the chain drum remains adjacent to the sidewalls over the entire rotation of the tailgate, thereby providing a large surface for material buildup when the tailgate is open. In comparison, the illustrated configuration provides substantially reduced available surfaces for material buildup.

As used herein, unless otherwise indicated herein, the terms “first,” “second,” etc. are used merely as labels. These identifiers are not intended to impose hierarchical, ordinal, or positional requirements on the items to which these terms refer. Moreover, reference to a “first” feature or item does not require the existence of a “second” or higher-numbered item.

Unless otherwise indicated herein, the term “or” is inclusive. For example, a description of a device as including a first component or a second component should be understood to include devices including the first component without the second component, devices including the second component without the first component, and devices including both the first component and the second component.

As used herein, the description of a system, apparatus, device, structure, article, element, component, or hardware as being “configured to” perform a specified function is indeed capable of performing the specified function without any alteration, rather than merely having potential to perform the specified function after further modification. In other words, the system, apparatus, structure, article, element, component, or hardware “configured to” perform the specified function is specifically selected, created, implemented, utilized, programmed, and/or designed for the purpose of performing the specified function. Further, as used herein, the term “configured to” denotes existing characteristics of the system, apparatus, structure, article, element, component, or hardware which enable the system, apparatus, structure, article, element, component, or hardware to perform the specified function without further modification.

While various aspects and embodiments have been disclosed herein, it will be apparent to those skilled in the art that various modifications and variations may be made to the devices and methods described here without departing from the scope of the disclosure. Accordingly, the present disclosure is intended to cover such modifications and variations of the disclosure, with the scope of the disclosure being set forth by the appended claims and their equivalents.

1. A rear eject truck body comprising:
a truck body container including a floor, opposing sidewalls, and an open rear end;
an ejector blade configured to move along the floor between a retracted position and an extended position toward the open rear end of the truck body container;
a tailgate extending across the open rear end of the truck body container and rotatable between an upper closed position and a lower open position; and
a tailgate operating system comprising:
a pulley disposed near the rear end of the truck body container,
a first tension line extending over the pulley, the first tension line including a rear end secured to the tailgate and a front end, and
a coupler secured to the front end of the tension line and configured to selectively engage the ejector blade such that movement of the ejector blade facilitates opening and closing of the tailgate.

2. The rear eject truck body according to claim 1, wherein the tailgate is part of a rotating structure and movement of the tailgate to the lower open position causes the entire rotating structure to separate from the sidewalls of the truck body so as to avoid material buildup on the tailgate.

3. The rear eject truck body according to claim 1, wherein the pulley is disposed within one of the sidewalls.

4. The rear eject truck body according to claim 1, wherein the pulley is in the vicinity of the tailgate when the tailgate is in the upper closed position.

5. The rear eject truck body according to claim 1, wherein the first tension line includes a chain or cable secured to the tailgate and a release rod extending from the chain or cable to the coupler.

6. The rear eject truck body according to claim 1, wherein the coupler is configured to engage the ejector blade upon operation of the ejector blade such that retraction of the ejector blade pulls the tailgate closed using the tailgate operating system.

7. The rear eject truck body according to claim 6, wherein extension of the ejector blade releases the first tension line thereby allowing the tailgate to open by the force of gravity.

8. The rear eject truck body according to claim 1, wherein the first tension line extends along a first sidewall of the truck body, and wherein the tailgate operating system includes a second tension line that extends along a second sidewall of the truck body container.

9. A haulage truck comprising:
a vehicle including a plurality of tires; and
a rear eject truck body according to claim 1 disposed on the vehicle.

10. The haulage truck according to claim 9, wherein the tires extend laterally outward under the opposing sides of the truck body container.

11. The haulage truck according to claim 9, wherein the first tension line extends over one of the tires.

12. A rear eject truck body comprising:
a truck body container including a floor, opposing sidewalls, and an open rear end;
an ejector blade configured to move along the floor between a retracted position and an extended position toward the open rear end of the truck body container;
a tailgate extending across the open rear end of the truck body container and rotatable between an upper closed position and a lower open position; and
a tailgate operating system comprising:
a pulley disposed near the rear end of the truck body container,
a first tension line extending over the pulley, the first tension line including a rear end and a front end, and
a coupler secured to the front end of the tension line and configured to selectively engage the ejector blade such that movement of the ejector blade facilitates operation of the tailgate operating system; and
a rotating structure including a tailgate, secured to the truck body container by a hinged coupling, and attached to the rear end of the first tension line, wherein operation of the tailgate operating system moves the rotating structure from a closed position, in which the tailgate is adjacent to the opposing sidewalls of the truck body container, toward an open position such that the entire rotating structure separates from the sidewalls of the truck body container so as to avoid material buildup on the tailgate.

13. The rear eject truck body according to claim 12, wherein the tailgate operating system includes a pulley and the first tension line extends over the pulley.

14. The rear eject truck body according to claim 12, wherein the first tension line includes a chain or cable secured to the tailgate and a release rod extending from the chain or cable to the coupler.

15. The rear eject truck body according to claim 12, wherein the coupler is configured to engage the ejector blade upon operation of the ejector blade such that retraction of the ejector blade pulls the tailgate closed using the tailgate operating system.

16. The rear eject truck body according to claim 15, wherein extension of the ejector blade releases the first tension line thereby allowing the tailgate to open by the force of gravity.

17. The rear eject truck body according to claim 1, wherein the first tension line extends along a first sidewall of the truck body, and wherein the tailgate operating system includes a second tension line that extends along a second sidewall of the truck body.

18. A tailgate operating system for an open top rear eject truck body, the tailgate operating system comprising:
a pulley disposed near a rear end of a truck body container,
a first tension line extending over the pulley, the first tension line including a rear end and a front end, the rear end being secured to a tailgate that is operable between opening and closing an open end of the truck body container, and
a coupler secured to the front end of the tension line and configured to selectively engage an ejector blade of the rear eject truck body such that movement of the ejector blade facilitates operation of the tailgate.

19. The tailgate operating system according to claim 18, wherein the first tension line includes a chain or cable secured to the tailgate and a release rod extending from the chain or cable to the coupler.

20. The tailgate operating system according to claim 18, wherein the coupler is configured to engage the ejector blade upon operation of the ejector blade such that retraction of the ejector blade pulls the tailgate closed using the tailgate operating system.
